(19) United States
(12) Patent Application Publication
(10) Pub. No.: US 2002/0007394 A1
(43) Pub. Date: Jan. 17, 2002

(54) Retrieving and processing stroed information using a distributed network of remote computers

(76) Inventors: Phillip Andre Bertolus, East Bentleigh (AU); Timothy Grant Lewis, Ascot Vale (AU)

Correspondence Address: Finnegan, Henderson, Farabow, Garrett & Dunner, L.L.P., 1300 I Street, N.W., Washington, DC, 20005-3315, US

(21) Appl. No.: 09/836,864

(22) Filed: Apr. 18, 2001

Related U.S. Application Data
(63) Continuation-in-part of application No. 09/551,583, filed on Apr. 18, 2000.

(51) Int. Cl. G06F 15/16

(52) U.S. Cl. 709/204

(57) ABSTRACT

A system retrieves and processes information stored on computers connected by a communications network. A central computer receives notification from a remote computer that the computer is available to receive data. In response to that notification, the central computer sends address data to the remote computer. To utilize the available network resources with maximum efficiency, the central computer optimizes performance of the distributed system by allocating address data to the remote computer based on at least one characteristic of the remote computer, such as a measure of network connectivity and/or on a performance characteristic of that remote computer. This allocation may take place in accordance with the relative importance of the data for indexing purposes. The remote computer uses a communication interface connected to the Internet to retrieve the information stored at the locations specified by the address data, and stores that information. The remote computer then processes the retrieved information to generate processed data, and stores the processed data. Finally, the remote computer sends the processed data to the central computer.

### RELATED APPLICATION

This is a continuation-in-part of application Ser. No. 09/551,583, filed Apr. 18, 2000.

### BACKGROUND OF THE INVENTION

A. Field of the Invention

The present invention relates generally to computer systems and methods for retrieving and indexing information on a network and, more particularly, to systems and methods used to retrieve and index information on the Internet. The present invention also relates to computer systems for maximizing efficiency of resource allocation on a network by differentially allocating tasks from a central computer to remote computers based on at least one characteristic of the remote computers.

B. Description of the Related Art

It is becoming increasingly common for computers to be connected to networks as part of their everyday operation. In particular, millions of computers around the world connect to the most well known Wide Area Network, the Internet, on a daily basis. A recent study (Steve Lawrence and C. Lee Giles, ‘Accessibility of information on the web’ (1999) 400 Nature 107) found that around 85% of Internet users use search engines to locate information, yet the largest coverage of a single search engine was, at the time of the study, only one-third of the estimated total size of the Internet.

As the Internet continues to grow in size at a rapid rate, it becomes more and more difficult to index it in a meaningful way without requiring massive amounts of storage space and computing power to process the results. The traditional indexing method has been to periodically trawl through the Internet, pulling in as much information as possible then parsing, indexing and ranking it using powerful central computers. The results of this process are stored in large databases which form the pool from which search results are drawn. This method suffers from an inherent inertia and lack of scalability, and is no longer able to keep up with the sheer amount of information being added to the Internet on a daily basis. Even with very powerful computers, the time taken to collect the data and process it can result in updates to search databases being weeks apart in some cases.

Increases in performance for “traditional” centralized systems such as this typically require large capital expenditure on new computers, extra storage space, and huge amounts of bandwidth to handle the large volume of raw information being retrieved for indexing. The data-collection agents doing the retrieving in most cases are programs called “spiders.” Also known as a crawler, robot or intelligent agent, a spider is a program that searches for information on the Internet. It is used to locate new documents and new sites by following hypertext links from server to server and indexing information based on various search criteria. Large amounts of data are generated by the spiders, and indexing that data represents a substantial portion of the processing load of most spider-based search engines.

As increased functionality is added to the Internet at the browser level, through the growing use of XML (Extensible Mark-up Language) for example, the volume of information and number of new pages being generated will continue to increase at a growing rate, posing an even greater challenge to search engines. Furthermore, the information on many pages is being updated in real time or close to it, meaning that search databases need to be constantly updated if they are to return relevant and timely results.

It is possible to continue to address this challenge with brute strength, adding extra servers and bandwidth at great expense, but a preferable solution is to devise a more efficient means for both indexing the Internet and for taking some of the processing load off the central computers, which can then focus on meeting users' search requests.

Most desktop computers today have a large amount of memory and very fast processors, both of which exceed the requirements of the user in most cases and as a result sit idle much of the time. Even high-powered workstations in universities and corporations can spend a large proportion of their time idle. In addition, these desktop computers and workstations are increasingly connected via local area networks to the Internet, making these computers potentially accessible from any computer in the world that is connected to the Internet or a similar network of computers.

Using idle remote computers to process information is known. For example, the SETI (Search for Extra-Terrestrial Intelligence) project uses idle computers to process radio telescope signals. Users of remote computers download a software application such that when the machine is idle, a screen-saver program launches which then processes raw data received earlier from the SETI server.

U.S. Pat. No. 5,964,832, entitled “Using Networked Remote Computers to Execute Computer Processing Tasks at a Predetermined Time” (Intel) discloses a system and method for distributing processing tasks to remote computers at a predetermined time.

Further, U.S. Pat. No. 6,098,091, entitled “Method and System Including a Central Computer that Assigns Tasks to Idle Workstations Using Availability Schedules and Computational Capabilities” (Intel) discloses a system and method for distributing indexing tasks by polling for available computers and matching the tasks to be processed with the most suitable computers available.

However, none of the above references recognize the excessive communication costs involved in such distributed computing systems, or disclose a means for achieving the full power and flexibility of a distributed computing system, while enabling minimization of the communication costs for the participants in such a system.

Based on the foregoing, there is a need for a system that optimises search engine performance by utilizing the unused processing capacity of networked remote computers to retrieve and process stored information on the Internet, in a manner that addresses the requirement for efficiency without incurring excessive communication costs.

### SUMMARY OF THE INVENTION

Methods, systems, and articles of manufacture consistent with the present invention provide a way of retrieving and processing stored information using the otherwise idle processor cycles of a remote computer that communicates with a central computer over a communications network. The remote computer notifies the central computer when it is available to retrieve and process stored information. On receiving such notification from the remote computer, the central computer sends address data to the remote computer. The central computer is able to optimize performance of the distributed system by allocating address data to the remote computer based on predetermined characteristics of the remote computer. It is to be noted that such predetermined characteristics of the remote computer may be internal performance attributes of that computer. Alternatively or additionally they may be external to that computer, relating to the location of that remote computer in a network. Ideally, then, in order to enable minimization of communications costs, the allocation of the address data is carried out with respect to the network connectivity of the remote computer and the network location of the stored information indicated by the address data. Using the received address data, the remote computer retrieves stored information and processes that information to generate processed data. The remote computer then stores the processed data and subsequently, at a predetermined time, sends it to the central computer.

### BRIEF DESCRIPTION OF THE DRAWINGS

The accompanying drawings, which are incorporated in and constitute a part of this specification, illustrate a non-limiting implementation of the invention and, together with the description, serve to explain the advantages and principles of the invention. In the drawings,

FIG. 1 is an illustration of a computer network for practicing methods and systems consistent with the present invention;

FIG. 2 is a schematic representation of the communications between a central computer and a remote computer consistent with the present invention;

FIG. 3 is a schematic representation of the process by which address data is allocated by a central computer to remote computers according to the relative importance of the information identified by the address data and at least one characteristic of the remote computer, in accordance with the present invention; and

FIG. 4 is a diagram illustrating the process of allocation of tasks to remote computers based on their network connectivity.

### DETAILED DESCRIPTION

The following detailed description of the invention refers to the accompanying drawings. Although the description includes exemplary implementations, other implementations are possible, and changes may be made to the implementations described without departing from the spirit and scope of the invention. The following detailed description does not limit the invention. Instead, the scope of the invention is defined by the appended claims. Wherever possible, the same reference numbers will be used throughout the drawings and the following description to refer to the same or like parts.

The present invention rather than have a centralized group of computers handle the entire task of retrieving, parsing, ranking and indexing information on the Internet in addition to meeting users' search requests, breaks the process into smaller tasks that are then performed by remote computers connected over a network. Instead of taking the bulk of the processing load, the central computers perform the far less intensive task of coordinating the efforts of a distributed group of remote computers, then receiving and collating the processed results. The computational resources of the search engine are thus directed more towards the “front end” service of meeting the users' search requests quickly and with a high degree of relevance.

Further efficiency can be achieved by recognizing that information accessible over the Internet is far from uniform. A large portion of material on the Internet is static in nature, changing rarely, so to index such material on a daily basis would place an unnecessary load on the network and the search engine. At the other end of the spectrum, some sites are constantly altered throughout each day (news sites for example), or are dynamically created in response to user requests or preferences. These are the sites where the bulk of the indexing efforts should be concentrated if the search engine is to return current and topical results.

Just as the quality of information stored at different locations differs widely, so too do the characteristics and attributes of the remote computers which participate in most distributed computing systems. In particular, the quality (in terms of speed and power) and the network connectivity of the remote computers (relative to the information to be accessed and indexed) differ widely. Each computer has a certain amount in common, for example they generally all have a microprocessor, some form of memory, some form of input/output device, a network interface, and a storage device. Important areas in which they differ, however, include processor speed, storage capacity, reliability, average amount of idle time, time spent connected to a network, their proximity in the network to information that is to be indexed, and the speed of their network connection. Each of these points of difference can affect the contribution a computer can make to a distributed computing system. Accordingly, the present invention optimizes search engine performance by utilizing the unused processing capacity of networked remote computers to retrieve and process stored information on the Internet, and by doing so in a way which seeks to match the tasks to be processed with the most suitable computers available at the time, without incurring undesirably high communication costs.

In addition, in accordance with the present invention, the owners of the remote computers may be offered various incentives for making their computers available for such use when they would otherwise be sitting idle. Owners of the remote computers are rewarded in proportion to the number of tasks or work units their computers process. Incentives include, for example, preferential access to search engine, free Internet service, free email accounts, discounts from selected vendors, or a percentage of advertising revenue.

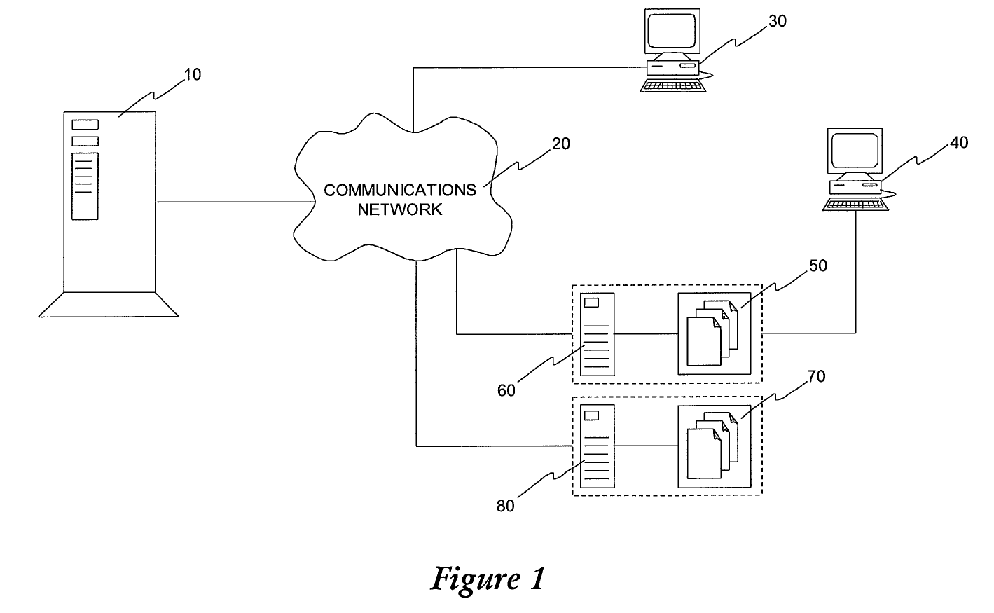

One embodiment of the present invention is a system for retrieving and processing information which is distributively stored on computers connected to a communications network. The system includes a remote computer that receives address data from a central computer. That basic arrangement is shown in FIG. 1. The distributed computer network includes a central computer 10, a communications network 20, one or more remote computers 30 and 40, and a plurality of pages of information 50 and 70 distributively stored on one or more computer systems 60 and 80 which are to be searched. All of the computers in FIG. 1 are connected, either directly or indirectly, to a communications network 20.

In one embodiment, the communications network 20 is the Internet, a Transmission Control Protocol/Internet Protocol (“TCP/IP”) based network, and the computers are connected to communications network 20 using technology in common use. For example remote computer 30 may be connected to communications network 20 using a modem connected to a telephone line, or via a network interface card connected to a local area network. In other embodiments of the present invention, communications network 20 is any device that allows the computers to communicate with each other. For example, communications network 20 can be a local area network, an Intranet, dedicated point-to-point communication lines, or a wireless transmission network. Further, communications network 20 might take a different form for different pairs of computers. For example, central computer 10 might communicate to a remote computer 30 via the Internet, and that remote computer 30 might communicate to computer system 60 via a local area network.

In another embodiment of the present invention, a remote computer 40 is connected to communications network 20 via another remote computer 60 which serves as an access provider. Remote computer 40 is connected to remote computer 60, and remote computer 60 is connected to communications network 20 using technology in common use. For example, remote computer 40 may be connected to remote computer 60 using a modem connected to a telephone line, or a network interface card connected to a local area network, and remote computer 60 may in turn be connected to communications network 20 using a point-to-point dedicated network connection such as a T3 line or any other technology in common use.

Although aspects of the present invention are described as being connected to one another, one skilled in the art will appreciate that various items of communication infrastructure may lie between those aspects, for example routers and switches.

Remote computer 60 may contain stored information which can be accessed by directly connected computers such as remote computer 40 or by indirectly connected computers such as remote computer 30 which are connected via communications network 20.

In one embodiment of the present invention, remote computer 60 is an Internet Service Provider (“ISP”) and communications network 20 is the Internet. Remote computers such as remote computer 40 connect to ISP 60 to access the Internet. ISP 60 also acts as an Internet server, containing stored information 50 such as HTTP (HyperText Transfer Protocol) files which can be accessed and retrieved by other computers connected to ISP 60 either directly or via the Internet.

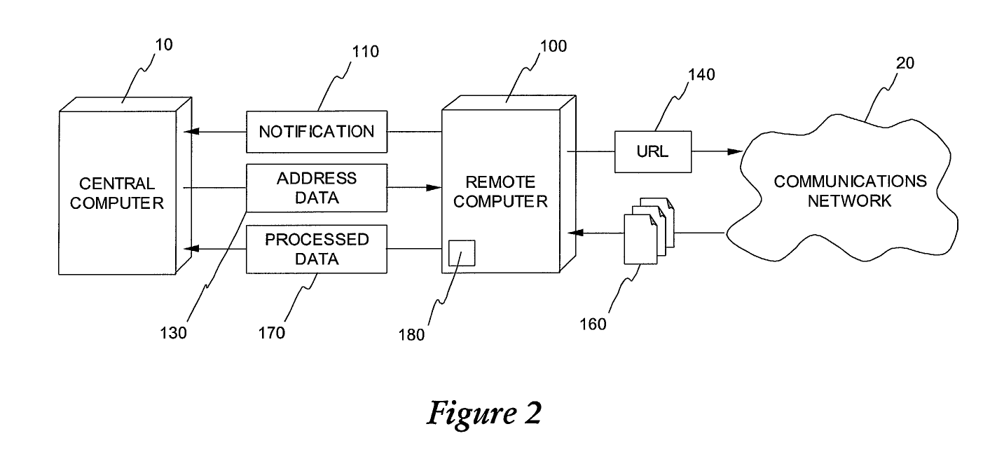

FIG. 2 is a diagram setting out the information flow between a central computer 10 and a remote computer 100 in one embodiment of the present invention. In one embodiment, the functionality of the steps performed by remote computer 100 is included in a processing application 180 that is stored on, and executed by, remote computer 100. The processing application may be stored in a memory, for example a hard drive, associated with remote computer 100. Remote computer 100 loads the processing application into its associated memory, for example its RAM, for executing the processing application. Although aspects of the present invention are described as being stored in memory, one skilled in the art will appreciate that these aspects may be stored on or read from other computer-readable media, such as secondary storage devices, like hard disks, floppy disks, and CD-ROM; a carrier wave received from a network like the Internet; or other forms of ROM or RAM.

At step 110, central computer 10 receives notification from remote computer 100 that remote computer 100 is available to receive address data. Following receipt of notification 110, central computer 10 sends address data 130 to remote computer 100. The address data indicates the location of the stored information to be retrieved by remote computer 100. Address data would typically comprise a batch of URLs (Universal Resource Locators) which in turn, for example, may indicate the location of HTTP (HyperText Transfer Protocol) sites or FTP (File Transfer Protocol) sites which contain stored information. The stored information can be located anywhere that is accessible by remote computer 100 either directly or via communications network 20.

Remote computer 100 stores address data 130 until such time as remote computer 100 would otherwise be idle, at which time it sends a request to the computer system on which stored information identified by URL 140 (which formed part of address data 130) is stored. In response to the request, the computer system on which the information identified by URL 140 is stored, sends the stored information 160 to remote computer 100. Otherwise, the stored information 160 is retrieved from the location indicated by the address data.

The remote computer 100 then processes the stored information 160 by executing a processing application 180. In one embodiment, the processing application 180 is downloaded from central computer 10 and installed on remote computer 100. In another embodiment, the processing application is supplied on a physical storage medium such as a CD-ROM or diskette, for example, and installed on remote computer 100. Then, remote computer 100 stores the processed data.

Finally, at step 170, remote computer 100 sends central computer 10 the processed data. The processed data may be sent in a compressed or uncompressed form, for example, via packet communication or data streaming.

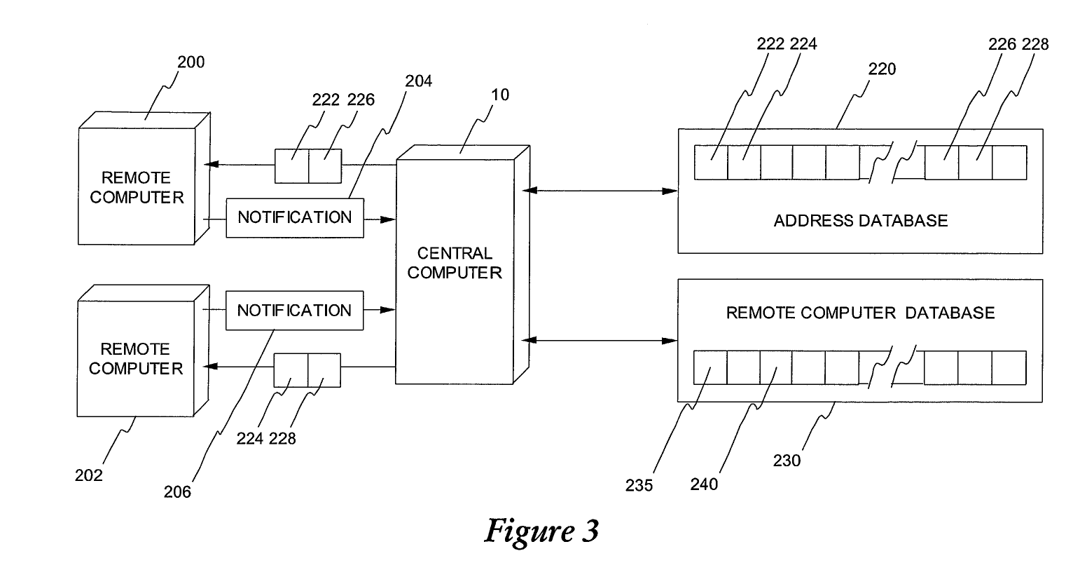

FIG. 3 is a diagram setting out the process by which address data is allocated by a central computer to remote computers according to the predetermined profile of the remote computer and the relative importance of the information identified by the address data. The remote computer 200 notifies the central computer 10 that it is available to receive address data. In one embodiment, this notification 204 is an automatic process which is initiated whenever the remote computer 200 becomes idle and is connected to a communications network at the time. In another embodiment, this notification 204 is a manual process which is initiated by the user of the remote computer 200.

After receiving notification 204 from remote computer 10, central computer 210 consults a remote computer database 230 to determine whether remote computer 200 has an existing database entry. Each remote computer which accepts address data from the central computer 10 has a corresponding profile created in the remote computer database 230. For example, profile 235 may be that of remote computer 200, and profile 240 may be that of remote computer 202. Profile 240 would then be updated each time remote computer 202 accepted address data and each time it sent processed data back to central computer 210.

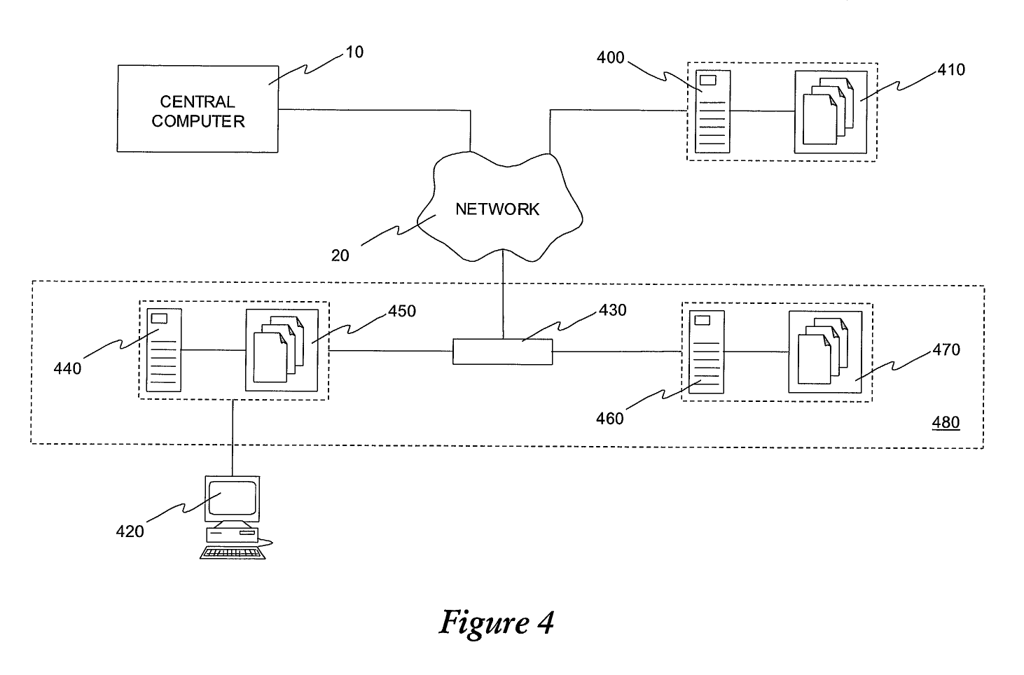

Each remote computer is ranked or differentiated according to its network connectivity, the nature of which ranking is set out in more detail in relation to FIG. 4 below. In addition, each remote computer is ranked or differentiated according to a benchmark figure which represents the average time that remote computer takes to process one unit of address data. This figure forms part of each remote computer's profile in the remote computer database 230. The time taken to process one unit of address data is taken as the period of time between the central computer sending out the unit of data and the central computer receiving back the processed data generated by the remote computer processing the information retrieved in accordance with that unit of address data. In another embodiment, the time taken to process one unit of data could be taken to end when the remote computer generates the processed data, instead of when the central computer actually receives that processed data. In FIG. 3 for example, the time taken for remote computer 200 to process the unit of address data 222 would begin when central computer 210 sent the unit of address data 222 to remote computer 200. The time period would end when central computer 210 received the processed data generated as a result of remote computer 200 retrieving the information at the location specified by the unit of address data 222, processing that information to generate processed data, then sending that processed data to central computer 210. In other embodiments each remote computer may be ranked by other criteria such as processor speed or the average amount of time the processor spends idle. Each remote computer can thus be given an overall ranking (i,e., a single predetermined characteristic) at the central computer based on a weighted combination of the various characteristics, the weighting depending on the specific priorities (cost/speed/repeatability/etc) of the distributed processing being undertaken.

The address data to be sent to remote computers is stored in an address database 220 and is ranked according to indexing priority. The indexing priority of a unit of address data is based on the frequency with which the information at the location indicated by that address data is revised or otherwise amended. For example, address 222 may have a high indexing priority because it corresponds to a site which is updated frequently, or which contains functionality that allows the automatic generation of new pages. At the other end of the spectrum, address 224 may have a low indexing priority because it corresponds to a site which is static and changes rarely, if at all. Based on their different indexing priorities, address 222 would be sent to remote computers for retrieval and indexing far more frequently than address 224. Address 224 can therefore be allocated to remote computers with lower rankings, as it does not have to be indexed with the same degree of speed and reliability as address 222, for example.

Where possible, address data with a high indexing priority, such as address 222, will be allocated to remote computers with a high ranking. This will decrease the probable length of time that the central computer will be left waiting for high priority units of address data to be returned.

In FIG. 3, for example, if remote computer 200 has a fixed Internet connection and is directly connected to the server on which the information to be indexed is stored, it will have a high ranking.

If remote computer 202 only has a sporadic connection to the Internet, and is far from the server on which the information to be indexed is stored, it will have a lower ranking than remote computer 200. On this basis, if remote computers 200 and 202 were each to notify central computer 10 that they were available to receive address data, central computer 10 would consult remote computer database 230 to determine the relative ranking of remote computers 200 and 202. Central computer 10 would also consult address database 220 to determine which address data was in need of indexing. If address data 222, 224, 226 and 228 required indexing, where 222 and 226 had a high indexing priority while 224 and 228 had a low indexing priority, then central computer 10 may allocate address data 222 and 226 to remote computer 200, and address data 224 and 228 to remote computer 202.

If the remote computer which is requesting address data does not have an entry in the remote computer database 230, then an an entry will be created and a low priority unit of address data will be sent to that remote by default. In one embodiment, the new entry in the remote database for the unknown remote computer will be automatically generated based on the unique Internet Protocol (“IP”) address of the remote computer. In another embodiment, the new entry in the remote database for the unknown remote computer will be based on data supplied by the user of the remote computer.

In the example of FIG. 4, central computer 10 and server computers 400, 440 and 460 are connected to communications network 20. A plurality of pages of information 410, 450 and 470 are stored on server computers 400, 440 and 460 respectively. Server computers 440 and 460 form a local area network (LAN) 480 and are connected to communications network 20 and to each other via a device 430 which uses technology in common use to forward information from one network to another. In a typical network, for example, device 430 would be a router which forwards data packets from one local area network (LAN) or wide area network (WAN) to another, reading the headers of each data packet to determine its destination.

The communication costs of network 480 can be substantially reduced if the “external” data traffic passing between network 480 and communications network 20 is minimized, and the “internal” data traffic within network 480 is maximized. While the cost savings may only be minimal per data transaction, the sheer volume of data transactions in a typical network means that the overall savings can be significant.

When remote computer 420 is connected to network 480, it is therefore preferable if the user of remote computer 420 accesses stored information 450 or 470, which is within network 480, instead of accessing stored information 410, which would require data to travel via communications network 20 and thus incur additional communication costs for network 480. If, for example, network 480 was an Internet Service Provider (ISP) and the user of remote computer 420 was a customer of that ISP, the ISP operators would prefer remote computer 420 to access stored information within their own network 480 to reduce their costs. As a result, many ISPs will store recently accessed information in cache memory within their own networks to reduce the necessity for that information to be retrieved from the Internet the next time it is requested by one of their customers. There is also an advantage to customers, in that reductions in the ISP's communication costs may be passed on to its customers as lower subscription rates.

To provide a greater incentive for computer users and their access providers to participate in distributed computing systems consistent with the present invention, address data is therefore allocated by central computer 10 to remote computers based on their network connectivity.

For example, when remote computer 420 notifies central computer 10 that it is available to receive address data, central computer 10 consults its remote computer database to determine the network profile of remote computer 420. As a result, central computer 10 then allocates address data to remote computer 420 which corresponds to information stored within network 480, for example a batch of URLs indicating the location of stored information 450 on server computer 440.

Remote computer 420 then retrieves and processes stored information 450, and sends the processed information to central computer 10. The only “external” communication is therefore the transmission of the address data from central computer 10 to remote computer 420, and the transmission of the processed information from remote computer 420 to central computer 10. If the address data allocated to remote computer 420 by central computer 10 had instead corresponded to stored information 410 on server computer 400, at least two additional “external” data transactions would have been required—the transmission of a request for stored information 410 from remote computer 420 to server computer 400, and the transmission of stored information 410 from server computer 400 to remote computer 420.

By selectively allocating address data to remote computers based on their network connectivity, a nominal saving in communication costs of approximately half can be achieved, in comparison with use of an allocation protocol which does not take network connectivity into account. There is also an associated reduction in bandwidth use between the ISP's web servers and the central computer, because the latter does not need to continually spider the contents of the ISP's web servers.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, one embodiment described includes a single remote computer. However, other embodiments include a plurality of remote computers, each of which executes the steps shown in FIG. 2.

It is intended that the specification and examples be considered as exemplary only, with the true scope and spirit of the invention being indicated by the following claims.

What is claimed is:

1. A method for retrieving and processing stored information in a network containing address data, comprising the steps of:
sending a message to a central computer in the network identifying a remote computer and indicating that the remote computer is available to retrieve and process stored information from address data;
receiving a processing message from the central computer including address data which has been selected by the central computer based on at least one characteristic of the remote computer;
retrieving and processing information from the address data; and
sending the processed information from the address data to a predetermined storage location.

2. The method of claim 1, wherein said at least one characteristic of the remote computer comprises a measure of the network connectivity of that remote computer.

3. The method of claim 2, wherein said measure of the network connectivity of the remote computer is determined with reference to at least one of the server computers to which the remote computer is connected.

4. The method of claim 1, wherein the step of selecting said address data includes a comparison of a processing characteristic of the remote computer with a priority listing of the address data.

5. The method of claim 4, wherein said priority listing for a particular data address is determined on the basis of activity at that address.

6. The method of claim 1, wherein said at least one characteristic of the remote computer comprises the time historically taken by that remote computer to process one unit of address data

7. The method of claim 1, wherein the remote computer communicates with the central computer over a Transmission Control Protocol/Internet Protocol based network.

8. The method of claim 1, wherein the remote computer communicates with the central computer over a local area network.

9. The method of claim 1, wherein the address data comprises a location of stored information on the Internet.

10. The method of claim 1, wherein the remote computer is directly connected to the computer on which the information to be retrieved is stored, such that the remote computer is able to retrieve said information without using the Internet.

11. The method of claim 1, wherein the step of sending a message to the central computer is initiated in response to a message from the central computer to ascertain if the remote computer is available to retrieve and process stored information from address data.

12. The method of claim 1, wherein processed information is stored in the remote computer and sent to the predetermined storage location at predetermined times.

13. The method of claim 1, wherein the processing message includes a task and the raw data, and the raw data is processed in accordance with the task.

14. The method of claim 1, wherein the address data comprises a batch of URLs (Universal Resource Locators).

15. The method of claim 1, wherein the processed information is sent to the central computer in a compressed and streamed format.

16. The method of claim 1, wherein the processed information is stored on at least one server computer communicating with the remote computer and the central computer.

17. A method for retrieving and processing stored information in a network containing address data, which is categorised into a priority listing, comprising the steps of:
sending a message from a remote computer to a central computer in the network identifying the remote computer and indicating that the remote computer is available to retrieve and process stored information from address data;
receiving the message in the central computer and comparing the identity of the remote computer to stored identities for remote computers in the central computer;
in response to a failure to identify the remote computer in the stored identities, optionally assigning an identity for the remote computer and a predetermined characteristic;
in response to a match identifying the remote computer in the stored identities, retrieving at least one characteristic of the remote computer from stored characteristics in the central computer;
assigning and sending a processing message to the remote computer including address data selected by comparison of at least one characteristic of the remote computer with the priority listing of the address data to retrieve;
retrieving and processing information from the address data by the remote computer; and
sending the processed information from the address data to a predetermined storage location.

18. The method of claim 17, wherein said at least one characteristic of the remote computer comprises a measure of the network connectivity of that remote computer.

19. The method of claim 18, wherein said measure of the network connectivity of the remote computer is determined with reference to at least one of the server computers to which the remote computer is connected.

20. The method of claim 17, wherein the step of selecting said address data includes a comparison of a processing characteristic of the remote computer with a priority listing of the address data.

21. The method of claim 17, wherein said priority listing for a particular data address is determined on the basis of activity at that address.

22. The method of claim 21, wherein said priority listing for a particular data address is determined on the basis of the frequency of updating the information at that address, or on the basis of the level of functionality associated with the information at that address.

23. The method of claim 17, wherein said at least one characteristic of the remote computer comprises the time historically taken by that remote computer to process one unit of address data.

24. The method of claim 17, wherein the remote computer communicates with the central computer over a Transmission Control Protocol/Internet Protocol based network.

25. The method of claim 17, wherein the remote computer communicates with the central computer over a local area network.

26. The method of claim 17, wherein the address data comprises a location of stored information on the Internet.

27. The method of claim 17, wherein the remote computer is directly connected to the computer on which the information to be retrieved is stored, such that the remote computer is able to retrieve said information without using the Internet.

28. The method of claim 17, wherein the step of sending a message to the central computer is initiated in response to a message from the central computer to ascertain if the remote computer is available to retrieve and process stored information from address data.

29. The method of claim 17, wherein processed information is stored in the remote computer and sent to the predetermined storage location at predetermined times.

30. The method of claim 17, wherein the processing message includes a task and the raw data, and the raw data is processed in accordance with the task.

31. The method of claim 17, wherein the address data comprises a batch of URLs (Universal Resource Locators).

32. The method of claim 17, wherein the processed information is sent to the central computer in a compressed and streamed format.

33. The method of claim 17, wherein the predetermined storage location is at least one server computer communicating with the remote computer and the central computer.

34. A remote computer for a system of retrieving and processing stored information in a network containing address data, comprising:
a message initiator to send a message to a central computer in the network identifying the remote computer and indicating that the remote computer is available to retrieve and process stored information from address data;
a message receiver for receiving a processing message from the central computer including address data which has been selected by the central computer by comparison of at least one characteristic of the remote computer with a priority listing of the address data
a processor for retrieving and processing information from the address data; and
a transmitter to send the processed information from the address data to a predetermined storage location.

35. A system for retrieving and processing stored information in a network containing address data comprising:
a message receiver to receive a message from a remote computer in the network identifying the remote computer and indicating that the remote computer is available to retrieve and process stored information from address data;
a comparator for comparing the identity of the remote computer to stored identities of remote computers and, in response to a failure to identify a remote computer in the stored identities, optionally assigning an identity for the remote computer and a predetermined characteristic;
a retriever to retrieve at least one characteristic of the remote computer from stored characteristics; and
a manager to assign and send a processing message to the remote computer including, address data selected by comparison of at least one characteristic of the remote computer with the priority listing of the address data to retrieve, and the predetermined storage location to which the processed information is to be sent.

36. A system for retrieving and processing stored information in a network containing address data, which is categorised into a priority listing, comprising:
means for receiving a processing message from the central computer including address data which has been selected by the central computer by comparison of at least one characteristic of the remote computer with a priority listing of the address data;
means for retrieving and processing information from the address data; and
means for sending the processed information from the address data to a predetermined storage location.

37. The system of claim 36, wherein said at least one characteristic of the remote computer comprises a measure of the network connectivity of that remote computer.

38. The system of claim 37, wherein said measure of the network connectivity of the remote computer is determined with reference to at least one of the server computers to which the remote computer is connected.

39. The system of claim 36, wherein the step of selecting said address data includes a comparison of a processing characteristic of the remote computer with a priority listing of the address data.

40. The system of claim 36, wherein said priority listing for a particular data address is determined on the basis of activity at that address.

41. The system of claim 36, wherein said at least one characteristic of the remote computer comprises the time historically taken by that remote computer to process one unit of address data.

42. The system of claim 36, wherein the remote computer communicates with the central computer over a Transmission Control Protocol/Internet Protocol based network.

43. The system of claim 36, wherein the remote computer communicates with the central computer over a local area network.

44. The system of claim 36, wherein the address data comprises a location of stored information on the Internet.

45. The system of claim 36, wherein the remote computer is directly connected to the computer on which the information to be retrieved is stored, such that the remote computer is able to retrieve said information without using the Internet.

46. The system of claim 36, including means for sending a message to the central computer initiated in response to a message from the central computer to ascertain if the remote computer is available to retrieve and process stored information from address data.

47. The system of claim 36, wherein processed information is stored in the remote computer and sent to the predetermined location at predetermined times.

48. The system of claim 36, wherein the processing message includes a task and the raw data, and the raw data is processed in accordance with the task.

49. The system of claim 36, wherein the address data comprises a batch of URLs (Universal Resource Locators).

50. The system of claim 36, wherein the processed information is sent to the central computer in a compressed and streamed format.

51. The system of claim 36, wherein the processed information is stored on at least one server computer communicating with the remote computer and the central computer.

52. A computer-readable medium containing a method for retrieving and processing stored information in a network containing address data, the method comprising the steps of:
sending a message to a central computer in the network identifying a remote computer and indicating that the remote computer is available to retrieve and process stored information from address data;
receiving a processing message from the central computer including address data which has been selected by the central computer based on at least one characteristic of the remote computer;
retrieving and processing information from the address data; and
sending the processed information from the address data to a predetermined storage location.

53. The computer-readable medium of claim 52, wherein said at least one characteristic of the remote computer comprises a measure of the network connectivity of that remote computer.

54. The computer-readable medium of claim 53, wherein said measure of the network connectivity of the remote computer is determined with reference to at least one of the server computers to which the remote computer is connected.

55. The computer-readable medium of claim 52, wherein the step of selecting said address data includes a comparison of a processing characteristic of the remote computer with a priority listing of the address data.

56. The computer-readable medium of claim 55, wherein said priority listing for a particular data address is determined on the basis of activity at that address.

57. The computer-readable medium of claim 52, wherein said at least one characteristic of the remote computer comprises the time historically taken by that remote computer to process one unit of address data

58. The computer-readable medium of claim 52, wherein the remote computer communicates with the central computer over a Transmission Control Protocol/Internet Protocol based network.

59. The computer-readable medium of claim 52, wherein the remote computer communicates with the central computer over a local area network.

60. The computer-readable medium of claim 52, wherein the address data comprises a location of stored information on the Internet.

61. The computer-readable medium of claim 52, wherein the remote computer is directly connected to the computer on which the information to be retrieved is stored, such that the remote computer is able to retrieve said information without using the Internet.

62. The computer-readable medium of claim 52, wherein the step of sending a message to the central computer is initiated in response to a message from the central computer to ascertain if the remote computer is available to retrieve and process stored information from address data.

63. The computer-readable medium of claim 52, wherein the processed information is stored in the remote computer and sent to the predetermined storage location at predetermined times.

64. The computer-readable medium of claim 52, wherein the processing message includes a task and the raw data, and the raw data is processed in accordance with the task.

65. The computer-readable medium of claim 52, wherein the address data comprises a batch of URLs (Universal Resource Locators).

66. The computer-readable medium of claim 52, wherein the processed information is sent to the central computer in a compressed and streamed format.

67. The computer-readable medium of claim 52, wherein the predetermined storage location is at least one server computer communicating with the remote computer of the central computer.

68. A computer-readable medium containing a method for retrieving and processing stored information in a network containing address data, which is categorised into a priority listing, the method comprising the steps of:
sending a message from a remote computer to a central computer in the network identifying the remote computer and indicating that the remote computer is available to retrieve and process stored information from address data;
receiving the message in the central computer and comparing the identity of the remote computer to stored identities for remote computer to stored identities for remote computer in the central computer;
in response to a failure to identify the remote computer in the stored identities, optionally assigning an identity for the remote computer and a predetermined characteristic;
in response to a match identifying the remote computer in the stored identities, retrieving at least one characteristic of the remote computer from stored characteristics in the central computer;
assigning and sending a processing message to the remote computer including address data selected by comparison of at least one characteristic of the remote computer with the priority listing of the address data to retrieve;
retrieving and processing information from the address data by the remote computer; and
sending the processed information from the address data to a predetermined storage location.

69. The computer-readable medium of claim 68, wherein said at least one characteristic of the remote computer comprises a measure of the network connectivity of that remote computer.

70. The computer-readable medium of claim 69, wherein said measure of the network connectivity of the remote computer is determined with reference to at least one of the server computers to which the remote computer is connected.

71. The computer-readable medium of claim 68, wherein the step of selecting said address data includes a comparison of a processing characteristic of the remote computer with a priority listing of the address data.

72. The computer-readable medium of claim 68, wherein said priority listing for a particular data address is determined on the basis of activity at that address.

73. The computer-readable medium of claim 68, wherein said at least one characteristic of the remote computer comprises the time historically taken by that remote computer to process one unit of address data

74. The computer-readable medium of claim 68, wherein the remote computer communicates with the central computer over a Transmission Control Protocol/Internet Protocol based network.

75. The computer-readable medium of claim 68, wherein the remote computer communicates with the central computer over a local area network.

76. The computer-readable medium of claim 68, wherein the address data comprises a location of stored information on the Internet.

77. The computer-readable medium of claim 68, wherein the remote computer is directly connected to the computer on which the information to be retrieved is stored, such that the remote computer is able to retrieve said information without using the Internet.

78. The computer-readable medium of claim 68, wherein the step of sending a message to the central computer is initiated in response to a message from the central computer to ascertain if the remote computer is available to retrieve and process stored information from address data.

79. The computer-readable medium of claim 68, wherein the processed information is stored in the remote computer and sent to the predetermined storage location at predetermined times.

80. The computer-readable medium of claim 68, wherein the processing message includes a task and the raw data. and the raw data is processed in accordance with the task.

81. The computer-readable medium of claim 68, wherein the address data comprises a batch of URLs (Universal Resource Locators).

82. The computer-readable medium of claim 68, wherein the processed information is sent to the central computer in a compressed and streamed format.

83. The computer-readable medium of claim 68, wherein the processed information is stored on at least one server computer communicating with the remote computer and the central computer.
